(19) United States
(12) Patent Application Publication
(10) Pub. No.: US 2012/0100198 A1
(43) Pub. Date: Apr. 26, 2012

(54) INSECT REPELLENT TEXTILE MATERIALS

(76) Inventors: Shulong Li, Spartanburg, SC (US); Kimila C. Cope, Boiling Springs, SC (US); Zeb W. Atkinson, Spartanburg, SC (US)

(21) Appl. No.: 12/909,908

(22) Filed: Oct. 22, 2010

(51) Int. Cl. A01N 25/34; B05D 3/00; A01N 43/40; A01N 53/06; A01P 7/04

(52) U.S. Cl. 424/403; 514/531; 514/315; 427/394; 427/389.9

(57) ABSTRACT

An insect repellent textile material comprises a textile substrate and at least one insect repellent compound disposed on at least one surface of the textile substrate. An insect repellent garment comprises a treated textile material as described above. A process for treating a textile material or garment comprises the steps of providing a textile material or garment, providing a liquid treatment composition, applying the liquid treatment composition to the textile material or garment, and drying the textile material or garment.

### TECHNICAL FIELD OF THE INVENTION

The invention relates to textile materials that have been treated so that the textile materials help to repel insects, especially biting insects such as mosquitoes.

### BACKGROUND

Though they have their rightful place in the animal kingdom and serve many beneficial purposes, insects can be a nuisance. Biting insects, such as fleas and mosquitoes, can be especially bothersome and serve as vectors for many dangerous infectious diseases. For example, mosquitoes are known vectors for diseases such as malaria, yellow fever, dengue fever, and Chikungunya.

The nuisance posed by insects can be mitigated by controlling the insect population. There are many means available to control insect populations, such as insecticides and predators. However, effectively controlling insect populations in developed settings (e.g., cities or towns) can be a daunting task, and doing so in undeveloped settings (e.g., forests or jungles) is, for all practical purposes, impossible. For those reasons, insect repellents are one of the more reliable and practical ways to reduce the nuisance and problems posed by insects.

There are many commercially-available insect repellent products that effectively repel insects and can reduce the likelihood of a person contracting insect-borne diseases. Many of these products are supplied in the form of sprays or lotions that must be applied to skin and/or clothing. Because these products are topically applied to the skin and/or clothing, they are prone to rubbing off when the user comes in contact with other surfaces and are removed when the user bathes and/or washes the clothing. Accordingly, such insect repellent products must be applied each time the user will be engaging in activities where she will be exposed to insects. Such reapplication can be tedious and, in situations such as those often encountered by soldiers on the battlefield, impractical or nearly impossible to repeat with the frequency needed to maintain the efficacy of the insect repellent product.

A need therefore remains for a means to deliver insect repellents that obviates the need for frequent reapplication in order to maintain their efficacy. The embodiments of the invention disclosed herein seek to provide such a means.

### BRIEF SUMMARY OF THE INVENTION

In a first embodiment, the invention provides a textile material that is treated with at least one insect repellent compound. The insect repellent compound can be selected from the group consisting of pyrethrins, pyrethroids, icaridin, and mixtures thereof. In a specific embodiment, the textile material comprises a textile substrate that comprises a plurality of first yarns and a plurality of second yarns. The first yarns comprise cellulosic fibers, and the cellulosic fibers comprise about 35% or more, by weight, of the fibers present in the first yarns. The second yarns comprise synthetic fibers, and the synthetic fibers comprise about 70% or more, by weight, of the fibers present in the second yarns. The first yarns are disposed in a first direction in the textile substrate, and the second yarns are disposed in a second direction perpendicular to the first direction. The first yarns and second yarns are further disposed within the textile substrate in a patternwise arrangement in which the first yarns are predominantly disposed on a first surface of the textile substrate and the second yarns are predominantly disposed on a second surface of the textile substrate opposite the first surface. Due to the construction of the textile substrate and the greater affinity of the insect repellent compound for the cellulosic fibers, the insect repellent compound is predominantly disposed on the first surface of the textile substrate.

In a second embodiment, the invention provides a garment comprising a treated textile material as described above. In such an embodiment, the garment can be, for example, a pair of pants, a shirt, a coat, a jacket, a hat, or a uniform.

In a third embodiment, the invention provides a process for treating a garment. More specifically, the invention provides a process for treating a garment with an insect repellent compound to impart insect repellent properties to the garment. In one embodiment, the process comprises the steps of providing a garment, providing a liquid treatment composition, applying the liquid treatment composition to the garment, and drying the garment. The garment comprises a textile substrate, such as the textile substrate described above in connection with the first embodiment of the invention. The liquid treatment composition comprises an insect repellent compound, such as those described above in connection with the first embodiment of the invention.

### DETAILED DESCRIPTION OF THE INVENTION

In a first embodiment, the invention provides a textile material that has been treated with at least one insect repellent compound. More specifically, the textile material comprises a textile substrate and an insect repellent compound. The insect repellent is disposed on at least one surface of the textile substrate.

The treated textile material can comprise any suitable textile substrate. The textile substrate can be a woven fabric, a knit fabric, or a nonwoven textile material, though woven fabrics are generally preferred for their durability and versatility. Thus, the textile substrate can comprise a plurality of yarns that have been interwoven or interlooped to produce a fabric structure. Such a textile substrate can be produced from a single type of yarn (i.e., from a plurality of the same type of yarn), or the textile substrate can be produced from two or more different types of yarn. In certain possibly preferred embodiments, the textile substrate comprises at least two different types of yarn, a plurality of first yarns and a plurality of second yarns.

The yarns used in making the textile substrate can be any suitable type of yarn. Preferably, the yarns are spun yarns. In such embodiments, the spun yarns can be made from a single type of staple fiber (e.g., spun yarns formed solely from cellulosic fibers), or the spun yarns can be made from a blend of two or more different types of staple fibers (e.g., spun yarns formed from a blend of cellulosic fibers and thermoplastic synthetic staple fibers, such as polyamide fibers). Such spun yarns can be formed by any suitable spinning process, such as ring spinning, air-jet spinning, or open-end spinning. In certain embodiments, the yarns are spun using a ring spinning process (i.e., the yarns are ring spun yarns).

The first yarns can comprise any suitable type of fiber or any suitable combination of fibers. In certain possibly preferred embodiments, the first yarns comprise cellulosic fibers. As utilized herein, the term “cellulosic fibers” refers to fibers composed of, or derived from, cellulose. Examples of suitable cellulosic fibers include cotton, rayon, linen, jute, hemp, cellulose acetate, and combinations, mixtures, or blends thereof. Preferably, the cellulosic fibers comprise cotton fibers.

In those embodiments of the textile substrate comprising cotton fibers, the cotton fibers can be of any suitable variety. Generally, there are two varieties of cotton fibers that are readily available for commercial use in North America: the American Upland variety (Gossypium hirsutum) and the American Pima variety (Gossypium barbadense). The cotton fibers used as the cellulosic fibers in the invention can be cotton fibers of either the American Upland variety, the American Pima variety, or a combination, mixture, or blend of the two varieties. Generally, cotton fibers of the American Upland variety, which comprise the majority of the cotton used in the apparel industry, have lengths ranging from about 0.875 inches to about 1.3 inches, while the less common fibers of the American Pima variety have lengths ranging from about 1.2 inches to about 1.6 inches. Preferably, at least some of the cotton fibers used in the invention are of the American Pima variety, which are preferred due to their greater, more uniform length.

In those embodiments in which the textile substrate comprises cellulosic fibers, the cellulosic fibers can be present in the yarns in any suitable amount. For example, in certain possibly preferred embodiments, the cellulosic fibers can comprise about 35% or more, about 40% or more, about 45% or more, or about 50% or more (e.g., about 50%), by weight, of the fibers present in one of the pluralities or types of yarn used in making the textile material. In certain possibly preferred embodiments, the yarn can include non-cellulosic fibers in addition to the cellulosic fibers. In such embodiments, the cellulosic fibers can comprise about 35% to about 75%, about 40% to about 70%, or about 45% to about 65% (e.g., about 45% to about 60% or about 45% to about 55%), by weight, of the fibers present in one of the pluralities or types of yarn used in making the textile material. In such embodiments, the remainder of the yarn can be made up of any suitable non-cellulosic fiber or combination of non-cellulosic fibers, such as the thermoplastic synthetic fibers discussed below.

In those embodiments in which the textile substrate comprises cellulosic fibers, the cellulosic fibers can be present in the textile material in any suitable amount. For example, in certain embodiments, the cellulosic fibers can comprise about 15% or more, about 20% or more, about 25% or more, about 30% or more, or about 35% or more, by weight, of the fibers present in the textile material. While the inclusion of cellulosic fibers can improve the comfort of the textile material (e.g., improve the hand and moisture absorbing characteristics), the inclusion of a high amount of cellulosic fibers can deleteriously affect the durability of the textile material. Accordingly, it may be desirable to limit the amount of cellulosic fiber in the textile material in order to achieve a desired level of durability. Thus, in certain embodiments, the cellulosic fibers can comprise about 75% or less, about 70% or less, about 65% or less, about 60% or less, about 55% or less, about 50% or less, or about 45% or less, by weight, of the fibers present in the textile material. More specifically, in certain embodiments, the cellulosic fibers can comprise about 15% to about 75%, about 20% to about 70%, about 25% to about 65% (e.g., about 25% to about 60%, about 25% to about 55%, about 25% to about 50% or about 25% to about 45%), about 30% to about 60% (e.g., about 30% to about 55%, about 30% to about 50% or about 30% to about 45%), or about 35% to about 55% (e.g., about 35% to about 50% or about 35% to about 45%), by weight, of the fibers present in the textile material.

In certain possibly embodiments of the invention, one or more of the yarns in the textile substrate can comprise thermoplastic synthetic fibers. For example, the first yarn can comprise a blend of cellulosic fibers and thermoplastic synthetic fibers. These thermoplastic synthetic fibers typically are included in the textile material in order to increase its durability to, for example, abrasion and industrial washing conditions. In particular, thermoplastic synthetic fibers tend to be rather durable to abrasion and harsh washing conditions employed in industrial laundry facilities and their inclusion in, for example, a cellulosic fiber-containing spun yarn can increase that yarn's durability to such conditions. The increased durability of the yarn, in turn, leads to an increased durability for the textile material. Suitable thermoplastic synthetic fibers include, but are not necessarily limited to, polyester fibers (e.g., poly(ethylene terephthalate) fibers, poly(propylene terephthalate) fibers, poly(trimethylene terephthalate) fibers), poly(butylene terephthalate) fibers, and blends thereof), polyamide fibers (e.g., nylon 6 fibers, nylon 6,6 fibers, nylon 4,6 fibers, and nylon 12 fibers), polyvinyl alcohol fibers, and combinations, mixtures, or blends thereof. In certain possibly preferred embodiments, the thermoplastic synthetic fibers are polyamide fibers, and preferably are nylon 6,6 fibers.

In those embodiments in which the textile substrate comprises thermoplastic synthetic fibers, the thermoplastic synthetic fibers can be present in one of the pluralities or types of yarn used in making the textile substrate in any suitable amount. In certain possibly preferred embodiments, the thermoplastic synthetic fibers comprise about 35% or more, about 40% or more, about 45% or more, or about 50% or more (e.g., about 50%), by weight, of the fibers present in one of the pluralities or types of yarn used in making the textile substrate. As noted above, the thermoplastic synthetic fibers can be blended with other fibers, such as cellulosic fibers, in one of the pluralities or types of yarn used in making the textile substrate. In certainly possibly preferred embodiments of such textile substrates, the thermoplastic synthetic fibers can comprise about 35% to about 75%, about 40% to about 70%, or about 45% to about 65% (e.g., about 45% to about 60% or about 45% to about 55%), by weight, of the fibers present in one of the pluralities or types of yarn used in making the textile substrate.

In one potentially preferred embodiment, the textile material comprises a plurality of yarns comprising a blend of cellulosic fibers and thermoplastic synthetic fibers (e.g., synthetic staple fibers). In this embodiment, the thermoplastic synthetic fibers can be any of those described above, with polyamide fibers (e.g., polyamide staple fibers) being particularly preferred. In such an embodiment, the cellulosic fibers comprise about 35% to about 75%, about 40% to about 70%, or about 45% to about 65% (e.g., about 45% to about 60% or about 45% to about 55%), by weight, of the fibers present in the yarn, and the polyamide fibers comprise about 35% to about 75%, about 40% to about 70%, about 45% to about 65% (e.g., about 45% to about 60% or about 45% to about 55%), by weight, of the fibers present in the yarn.

As noted above, in certain possibly preferred embodiments, the textile substrate can comprise a plurality of second yarns in addition to the plurality of first yarns. The second yarns can contain any suitable fiber or combination of fibers. In certain possibly preferred embodiments, the second yarns comprise synthetic fibers. The synthetic fibers present in such an embodiment of the second yarn can all be the same type of fiber (e.g., all meta-aramid fibers), or the yarn can contain a combination or blend of different synthetic fibers (e.g., a blend of meta-aramid fibers and para-aramid fibers). These synthetic fibers can be any synthetic fiber that exhibits a poor affinity towards an insect repellent compound. In certain possibly preferred embodiments, the second yarns comprise an inherently flame resistant fiber such as aramid fibers, polybenzimidazole fibers, flame resistant rayon fibers, flame resistant modacrylic fibers, polysulfonamide fibers (e.g., sulfo-aramid fibers), polyimide fibers, polyamide-imide fibers, polypyridobisimidazole fibers, polyoxadiazole fibers, and partially oxidized or carbonized fibers. As utilized herein, the term “aramid fiber” refers to a manufactured fiber in which the fiber-forming material is a long chain synthetic polyamide having a substantial portion of its amide linkages (e.g., at least 85%) directly attached to two aromatic rings. Suitable aramid fibers include, but are not necessarily limited to, meta-aramid fibers (e.g., poly-m-phenylene isophthalamide fibers, such as NOMEX® fibers commercially available from DuPont), para-aramid fibers (e.g., poly-p-phenylene terephthalamide fibers, such as KEVLAR® fibers commercially available from DuPont), and combinations, mixtures, or blends thereof.

When present in the second yarns, the synthetic fibers can be present in the second yarns in any suitable amount. In certain possibly preferred embodiments, the synthetic fibers comprise about 80% or more, about 85% or more, about 90% or more, or about 95% or more, by weight, of the fibers present in the second yarns. In such embodiments, the recited amounts can be obtained from one type of synthetic fiber (e.g., all meta-aramid fibers), or the recited amounts can be obtained from two or more different types of synthetic fibers (e.g., a blend of meta-aramid fibers and para-aramid fibers). In certain possibly preferred embodiments, the second yarns comprise about 80% or more, about 85% or more, about 90% or more (e.g., about 90% to about 95% or about 93% to about 95%), by weight, meta-aramid fibers. In certain possibly preferred embodiments, the second yarns comprise about 1% or more (e.g., about 1% to about 10%), about 2% or more, about 3% or more, about 4% or more, or about 5% or more (e.g., about 5% to about 10%), by weight, para-aramid fibers. In certain possibly preferred embodiments, the second yarns comprise a blend of meta-aramid fibers and para-aramid fibers. In one such embodiment, the second yarns comprise a blend of meta-aramid fibers and para-aramid fibers containing about 90% to about 95% (e.g., about 90% or about 95%), by weight, meta-aramid fibers and about 1% to about 10% or about 1% to about 5% (e.g., about 5%), by weight, para-aramid fibers.

In certain possibly preferred embodiments, the second yarns further comprise static dissipative or antistatic fibers. The static dissipative or antistatic fibers can be any suitable fiber which helps to dissipate or inhibit the buildup of a substantial static charge in the fiber or a yarn or fabric containing the same. Suitable static dissipative fibers include, but are not limited to, carbon fibers, such as P140 antistatic carbon fibers commercially available from DuPont. When present in the second yarns, the static dissipative or antistatic fibers can be present in each of the yarns in an amount up to about 4%, by weight, based on the total weight of each yarn. In certainly possibly preferred embodiments, the second yarns comprise about 0.5% to about 3% or about 1% to about 3% (e.g., or about 1% to about 2%), by weight, static dissipative or antistatic fibers, based on the total weight of each yarn.

The textile materials of the invention can be any suitable construction. In other words, the yarns forming the textile material can be provided in any suitable patternwise arrangement producing a fabric. Preferably, the textile materials are provided in a woven construction, so that there is a first plurality of yarns (e.g., the first yarns) disposed in a first direction in the textile substrate and a second plurality of yarns (e.g., the second yarns) disposed in a second direction perpendicular to the first direction. The textile material can be provided in any suitable woven construction, such as a plain weave, basket weave, twill weave, satin weave, or sateen weave. Suitable plain weaves include, but are not limited to, ripstop weaves produced by incorporating, at regular intervals, extra yarns or reinforcement yarns in the warp, fill, or both the warp and fill of the textile material during formation. Suitable twill weaves include both warp-faced and fill-faced twill weaves, such as 2/1, 3/1, 3/2, 4/1, 1/2, 1/3, or 1/4 twill weaves. In certain embodiments of the invention, such as when the textile material is formed from two or more pluralities or different types of yarns, the yarns are disposed in a patternwise arrangement in which one of the yarns is predominantly disposed on one surface of the textile material. In other words, one surface of the textile material is predominantly formed by one yarn type. Suitable patternwise arrangements or constructions that provide such a textile material include, but are not limited to, satin weaves, sateen weaves, and twill weaves in which, on a single surface of the fabric, the fill yarn floats and the warp yarn floats are of different lengths.

As noted above, the textile material comprises at least one insect repellent compound. The insect repellent compound can be any suitable compound which discourages insects (e.g., flying insects, such as mosquitoes) from landing or climbing on a surface to which the compound has been applied. Suitable insect repellents include, but are not limited to, pyrethrins (e.g., pyrethrin I and/or pyrethrin II), pyrethroids, icaridin (i.e., hydroxyethyl isobutyl piperidine carboxylate or 1-piperidinecarboxylic acid 2-(2-hydroxyethyl)-1-methylpropylester), and mixtures or combinations thereof. Suitable pyrethroids include, but are not limited to, allethrin (e.g., allethrin I and/or allethrin II), bifenthrin, beta-cyfluthrin, cyphenothrin, imiprothrin, permethrin, resmethrin, sumithrin, and transfluthrin. In certain possibly preferred embodiments, the insect repellent compound is a pyrethroid, such as permethrin.

The insect repellent compound is disposed on at least one surface of the textile substrate. Applicants have found that insect repellent compounds generally exhibit a greater affinity for cellulosic fibers than synthetic fibers (e.g., thermoplastic synthetic fibers and aramid fibers). Accordingly, in those embodiments in which different yarns are predominantly disposed on different surfaces of the textile substrate, the insect repellent compound can be predominantly disposed on the surface of the textile substrate that contains a greater amount of cellulosic fibers. Of course, some insect repellent compound may still be present on the other surface of the textile substrate, but the amount of insect repellent compound per unit of area preferably is greater on the surface that contains a greater amount of cellulosic fibers.

The insect repellent compound can be present in the textile substrate in any suitable amount. The suitable amount of insect repellent compound may depend upon several factors, such as the efficacy of the particular insect repellent compound, the desired degree of repellency, and safe and/or accepted levels of exposure for the particular insect repellent compound. In those embodiments in which the insect repellent compound is a pyrethroid (e.g., permethrin), the insect repellent compound typically is present in an amount of about 0.14 mg/cm² (e.g., 0.1375 mg/cm²) or less, based on the area of the textile substrate. When the insect repellent compound is a pyrethroid (e.g., permethrin), the insect repellent compound typically is present in an amount of about 0.05 mg/cm² or more, based on the area of the textile substrate. In certain possibly preferred embodiments, the insect repellent compound is a pyrethroid (e.g., permethrin) and is present in an amount of about 0.05 to about 0.14 mg/cm², about 0.08 to about 0.14 mg/cm², or about 0.1 to about 0.14 mg/cm², based on the area of the textile substrate.

In order to increase the durability of the insect repellent treatment, the textile material may, in certain possibly preferred embodiments, further comprise a binder. To increase the durability of the insect repellent treatment, at least a portion of the binder is disposed on the same surface as the insect repellent compound and, when the insect repellent compound is predominantly disposed on one surface of the textile substrate, the binder preferably is predominantly disposed on the same surface of the textile substrate. The binder can be any binder suitable for use on textile materials. In certain possibly preferred embodiments, the binder is selected from the group consisting of acrylic copolymers, vinyl chloride copolymers, ethylene-vinyl acetate copolymers, styrene-butadiene copolymers, polyurethanes, polyolefins, and mixtures thereof. When present on the textile substrate, the binder can be present in any suitable amount. In certain possibly preferred embodiments, the binder is present on the textile substrate in an amount of about 0.2 parts to about 10 parts, about 1 part to about 8 parts, or about 2 parts to about 5 parts per part of the insect repellent compound present on the textile substrate.

In certain possibly preferred embodiments, the textile material further comprises a flame retardant finish applied to at least one surface of the textile substrate. Typically, such flame retardant treatments or finishes are applied to a textile material containing cellulosic fibers in order to impart flame resistant properties to the cellulosic portion of the textile material. In such embodiments, the flame retardant treatment or finish can be any suitable treatment. Suitable treatments include, but are not limited to, halogenated flame retardants (e.g., brominated or chlorinated flame retardants), phosphorous-based flame retardants, antimony-based flame retardants, nitrogen-containing flame retardants, and combinations, mixtures, or blends thereof.

In one preferred embodiment, the textile material comprises cellulosic fibers and has been treated with a phosphorous-based flame retardant treatment. In this embodiment, a tetrahydroxymethyl phosphonium salt, a condensate of a tetrahydroxymethyl phosphonium salt, or a mixture thereof is first applied to the textile material. As utilized herein, the term “tetrahydroxymethyl phosphonium salt” refers to salts containing the tetrahydroxymethyl phosphonium (THP) cation, which has the structure

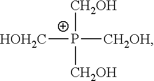

and includes, but is not limited to, the chloride, sulfate, acetate, carbonate, borate, and phosphate salts. As utilized herein, the term “condensate of a tetrahydroxymethyl phosphonium salt” (THP condensate) refers to the product obtained by reacting a tetrahydroxymethyl phosphonium salt, such as those described above, with a limited amount of a cross-linking agent, such as urea, guanazole, or biguanide, to produce a compound in which at least some of the individual tetrahydroxymethyl phosphonium cations have been linked through their hydroxymethyl groups. The structure for such a condensate produced using urea is set forth below

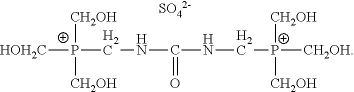

The synthesis of such condensates is described, for example, in Frank et al., Textile Research Journal, November 1982, pages 678-693 and Frank et al., Textile Research Journal, December 1982, pages 738-750. These THPS condensates are also commercially available, for example, as PYROSAN® CFR from Emerald Performance Materials.

The THP or THP condensate can be applied to the textile material in any suitable amount. Typically, the THP salt or THP condensate is applied to the textile material in an amount that provides at least 0.5% (e.g., at least 1%, at least 1.5%, at least 2%, at least 2.5%, at least 3%, at least 3.5%, at least 4%, or at least 4.5%) of elemental phosphorus based on the weight of the untreated textile material. The THP salt or THP condensate is also typically applied to the textile in an amount that provides less than 5% (e.g., less than 4.5%, less than 4%, less than 3.5%, less than 3%, less than 2.5%, less than 2%, less than 1.5%, or less than 1%) of elemental phosphorus based on the weight of the untreated textile material. Preferably, the THP salt or THP condensate is applied to the textile material in an amount that provides about 1% to about 4% (e.g., about 1% to about 3% or about 1% to about 2%) of elemental phosphorous based on the weight of the untreated textile material.

Once the THP salt or THP condensate has been applied to the textile material, the THP salt or THP condensate is then reacted with a cross-linking agent. The product produced by this reaction is a cross-linked phosphorus-containing flame retardant polymer. The cross-linking agent is any suitable compound that enables the cross-linking and/or curing of THP. Suitable cross-linking agents include, for example, urea, a guanidine (i.e., guanidine, a salt thereof, or a guanidine derivative), guanyl urea, glycoluril, ammonia, an ammonia-formaldehyde adduct, an ammonia-acetaldehyde adduct, an ammonia-butyraldehyde adduct, an ammonia-chloral adduct, glucosamine, a polyamine (e.g., polyethyleneimine, polyvinylamine, polyetherimine, polyethyleneamine, polyacrylamide, chitosan, aminopolysaccharides), glycidyl ethers, isocyanates, blocked isocyanates and combinations thereof. Preferably, the cross-linking agent is urea or ammonia, with urea being the more preferred cross-linking agent.

The cross-linking agent can be applied to the textile material in any suitable amount. The suitable amount of cross-linking agent varies based on the weight of the textile material and its construction. Typically, the cross-linking agent is applied to the textile material in an amount of at least 0.1% (e.g., at least 1%, at least 2%, at least 3%, at least 5%, at least 7%, at least 10%, at least 15%, at least 18%, or at least 20%) based on the weight of the untreated textile material. The cross-linking agent is also typically applied to the textile material in an amount of less than 25% (e.g., less than 20%, less than 18%, less than 15%, less than 10%, less than 7%, less than 5%, less than 3%, or less than 1%) based on the weight of the untreated textile material. In a potentially preferred embodiment, the cross-linking agent is applied to the textile material in an amount of about 2% to about 7% based on the weight of the untreated textile material.

In order to accelerate the condensation reaction of the THP salt or THP condensate and the cross-linking agent, the above-described reaction can be carried out at elevated temperatures. The time and elevated temperatures used in this curing step can be any suitable combinations of times and temperatures that result in the reaction of the THP or THP condensate and cross-linking agent to the desired degree. The time and elevated temperatures used in this curing step can also promote the formation of covalent bonds between the cellulosic fibers and the phosphorous-containing condensation product, which is believed to contribute to the durability of the flame retardant treatment. However, care must be taken not to use excessively high temperatures or excessively long cure times that might result in excessive reaction of the flame retardant with the cellulosic fibers, which might weaken the cellulosic fibers and the textile material. Furthermore, it is believed that the elevated temperatures used in the curing step can allow the THP salt or THP condensate and cross-linking agent to diffuse into the cellulose fibers where they react to form a cross-linked phosphorus-containing flame retardant polymer within the fibers. Suitable temperatures and times for this curing step will vary depending upon the curing oven used and the speed with which heat is transferred to the textile material, but suitable conditions can range from temperatures of about 149° C. (300° F.) to about 177° C. (350° F.) and times from about 1 minute to about 3 minutes.

In the case where ammonia is used as the cross-linking agent, it is not necessary to use elevated temperatures for the THP salt or THP condensate and cross-linking agent to react. In such case, the reaction can be carried out, for example, in a gas-phase ammonia chamber at ambient temperature. A suitable process for generating a phosphorous-based flame retardant using this ammonia-based process is described, for example, in U.S. Pat. No. 3,900,664 (Miller), the disclosure of which is hereby incorporated by reference.

After the THP salt or THP condensate and cross-linking agent have been cured and allowed to react to the desired degree, the resulting textile material can be exposed to an oxidizing agent. While not wishing to be bound to any particular theory, it is believed that this oxidizing step converts the phosphorous in the condensation product (i.e., the condensation product produced by the reaction of the THP salt or THP condensate and cross-linking agent) from a trivalent form to a more stable pentavalent form. The resulting phosphorous-containing compound (i.e., cross-linked, phosphorous-containing flame retardant polymer) is believed to contain a plurality of pentavalent phosphine oxide groups. In those embodiments in which urea has been used to cross-link the THP salt or THP condensate, the phosphorous-containing compound comprises amide linking groups covalently bonded to the pentavalent phosphine oxide groups, and it is believed that at least a portion of the phosphine oxide groups have three amide linking groups covalently bonded thereto.

The oxidizing agent used in this step can be any suitable oxidant, such as hydrogen peroxide, sodium perborate, or sodium hypochlorite. The amount of oxidant can vary depending on the actual materials used, but typically the oxidizing agent is incorporated in a solution containing at least 0.1% concentration (e.g., at least 0.5%, at least 0.8, at least 1%, at least 2%, or at least 3% concentration) and less than 20% concentration (e.g., less than 15%, less than 12%, less than 10%, less than 3%, less than 2%, or less than 1% concentration) of the oxidant.

After contacting the treated textile material with the oxidizing agent, the cured textile material preferably is contacted with a neutralizing solution (e.g., a caustic solution with a pH of at least 8, at least pH 9, at least pH 10, at least pH 11, or at least pH 12). The actual components of the caustic solution can widely vary, but suitable components include any strong base, such as alkalis. For example, sodium hydroxide (soda), potassium hydroxide (potash), calcium oxide (lime), or any combination thereof can be used in the neutralizing solution. The amount of base depends on the size of the bath and is determined by the ultimately desired pH level. A suitable amount of caustic in the solution is at least 0.1% concentration (e.g., at least 0.5%, at least 0.8, at least 1%, at least 2%, or at least 3% concentration) and is less than 10% concentration (e.g., less than 8%, less than 6%, less than 5%, less than 3%, less than 2%, or less than 1% concentration). The contact time of the treated textile material with the caustic solution varies, but typically is at least 30 seconds (e.g., at least 1 min, at least 3 min, at least 5 min, or at least 10 min). If desired, the neutralizing solution can be warmed (e.g., up to 75° C., up to 70° C., up to 60° C., up to 50° C., up to 40° C., up to 30° C. relative to room temperature).

Generally, the insect repellent treatment described herein has been observed to have little effect on the air permeability and softness of the textile substrate. Thus, the textile materials according to the invention can, depending on the particular textile substrate selected, be air permeable and comfortable to wear.

If desired, the textile material can be treated with one or more softening agents (also known as “softeners”) to improve the hand of the treated textile material. The softening agent selected for this purpose should not have a deleterious effect on the flammability of the resultant fabric. Suitable softeners include polyolefins, ethoxylated alcohols, ethoxylated ester oils, alkyl glycerides, alkylamines, quaternary alkylamines, halogenated waxes, halogenated esters, silicone compounds, and mixtures thereof.

To further enhance the textile material's hand, the textile material can optionally be treated using one or more mechanical surface treatments. A mechanical surface treatment typically relaxes stress imparted to the fabric during curing and fabric handling, breaks up yarn bundles stiffened during curing, and increases the tear strength of the treated fabric. Examples of suitable mechanical surface treatments include treatment with high-pressure streams of air or water (such as those described in U.S. Pat. No. 4,918,795, U.S. Pat. No. 5,033,143, and U.S. Pat. No. 6,546,605), treatment with steam jets, needling, particle bombardment, ice-blasting, tumbling, stone-washing, constricting through a jet orifice, and treatment with mechanical vibration, sharp bending, shear, or compression. A sanforizing process may be used instead of, or in addition to, one or more of the above processes to improve the fabric's hand and to control the fabric's shrinkage. Additional mechanical treatments that may be used to impart softness to the treated fabric, and which may also be followed by a sanforizing process, include napping, napping with diamond-coated napping wire, gritless sanding, patterned sanding against an embossed surface, shot-peening, sand-blasting, brushing, impregnated brush rolls, ultrasonic agitation, sueding, engraved or patterned roll abrasion, and impacting against or with another material, such as the same or a different fabric, abrasive substrates, steel wool, diamond grit rolls, tungsten carbide rolls, etched or scarred rolls, or sandpaper rolls.

As noted above, the invention also provides a garment comprising a treated textile material according to the invention. The garment can be constructed entirely from the treated textile material according to the invention, or the garment can be constructed from a combination of different treated textile materials, at least one of which is a treated textile material according to the invention. The garment can be any suitable garment, such as a pair of pants, a shirt, a coat, a jacket, a hat, or a uniform (e.g., a military battle dress uniform).

In an additional embodiment, the invention provides a process for treating a textile material or a garment. The process comprises the steps of providing a textile material or garment, providing a liquid treatment composition, applying the liquid treatment composition to the textile material or garment, and drying the textile material or garment. The textile material or garment comprises a textile substrate, such as the textile substrate described above in connection with the first embodiment of the invention. The liquid treatment composition comprises an insect repellent compound, such as those described above in connection with the first embodiment of the invention.

As noted above, the liquid treatment composition comprises an insect repellent compound, such as pyrethrins, pyrethroids, icaridin, and mixtures thereof. The liquid treatment composition typically contains a solvent in which the insect repellent compound is dissolved or a liquid medium in which the insect repellent compound is dispersed or emulsified. Suitable solvents include, but are not limited to, hydrocarbons, such as naphtha. The amount of insect repellent compound will depend upon several factors, such as, for example, the particular insect repellent compound used, the amount of insect repellent compound to be deposited onto the textile material, and the wet pickup of the textile material. In certain possibly preferred embodiments, such as when the insect repellent compound is a pyrethroid (e.g., permethrin), the insect repellent compound can be present in the liquid treatment composition in an amount of about 0.2% to about 0.8%, based on the total weight of the liquid treatment composition.

In certain possibly preferred embodiments, the liquid treatment composition further comprises a binder, such as the binders described above in the discussion of the first embodiment of the invention. In certain possibly preferred embodiments, the binder is selected from the group consisting of acrylic copolymers, vinyl chloride copolymers, ethylene-vinyl acetate copolymers, styrene-butadiene copolymers, polyurethanes, polyolefins, and mixtures thereof. In certain possibly preferred embodiments, the binder can be provided in the form of a latex, which is a stable dispersion or emulsion of polymer microparticles in an aqueous medium. When the binder is present in the liquid treatment composition and is provided in the form of a latex, the aqueous medium of the latex can provide a medium in which the insect repellent compound can be dispersed or emulsified. For example, the insect repellent compound and the latex can be combined and heated to a temperature sufficient to melt the insect repellent compound and the resulting mixture can then be mixed (e.g., high shear mixed) to form a stable emulsion. Alternatively, if the insect repellent compound is dissolved in a suitable organic solvent, this insect repellent compound solution can be combined with the latex and the resulting mixture can then be mixed (e.g., high shear mixed) to form a stable emulsion.

In certain possibly preferred embodiments, the liquid treatment composition further comprises an emulsifying agent, such as an ethoxylated alcohol. It is believed that the use of an emulsifying agent is another way one can produce a suitable liquid treatment composition without the need to use volatile organic compounds. When an emulsifying agent is present in the liquid treatment composition, the insect repellent compound and the emulsifying agent can be mixed with water or another suitable aqueous medium to produce an emulsion. This emulsion can then be applied to the textile material or garment as described below.

The liquid treatment composition can be applied to the textile material or garment using any suitable application technique. For example, the textile material or garment can be immersed or dipped into the liquid treatment composition and then passed through one or more nip rollers to remove excess liquid treatment composition from the textile material or garment and yield the desired wet pickup of the liquid treatment composition. Alternatively, the textile material or garment can be sprayed or otherwise impregnated with the liquid treatment composition using any suitable spraying apparatus to yield the desired wet pickup of the liquid treatment composition. In those embodiments of the process in which a garment is being treated, the garment preferably is turned right-side-out and, if the garment has buttons or other fasteners, these are fastened so that the garment remains in a right-side-out orientation and the liquid treatment composition is applied to the outside surfaces of the garment.

The amount of the liquid treatment composition applied to the textile material or garment will depend upon several factors, such as the concentration of the insect repellent compound in the treatment composition and the desired amount of insect repellent compound to be deposited on the textile material or garment. In certain possibly preferred embodiments, the liquid treatment composition is applied to the textile material or garment in an amount sufficient to yield a wet pickup of about 25% or more, about 30% or more, about 35% or more, about 40% or more, about 45% or more, about 50% or more, or about 55% or more, based on the weight of the dry textile material or garment. Generally, the wet pickup should not be so high that the textile material or garment becomes saturated or the drying time for the textile material or garment becomes impractically long. In certain possibly preferred embodiments, the liquid treatment composition is applied to the textile material or garment in an amount to yield a wet pickup of about 100% or less, about 95% or less, about 90% or less, about 85% or less, or about 80% or less, based on the weight of the dry textile material or garment. Thus, in certain possibly preferred embodiments, the liquid treatment composition is applied to the textile material or garment in an amount to yield a wet pickup of about 45% to about 95%, about 50% to about 90%, or about 55% to about 85%, based on the weight of the dry textile material or garment.

Following the application of the liquid treatment composition, the textile material or garment can be dried using any suitable drying apparatus for any suitable time and at any suitable temperature. For example, the textile material or garment can be dried using a conventional tumble dryer. As noted above, the textile material or garment can be dried at any suitable temperature. For example, the textile material or garment can be dried at a temperature of about 35° C. to about 160° C. (e.g., about 40° C. to about 160° C. or about 35° C. to about 85° C.), about 50° C. to about 140° C., or about 60° C. to about 120° C. Generally, the textile material or garment is dried at a temperature that does not exceed 160° C. so as to avoid excessive volatilization of the insect repellent compound. During the drying process, the textile material or garment preferably is maintained in a right-side-out orientation and, if the textile material or garment has buttons or other fasteners, these are fastened so that the textile material or garment is maintained in a right-side-out orientation, exposing the outside surfaces to the hot air or heat source. The amount of time necessary to appropriately dry the textile material or garment may depend upon several factors, such as the type of textile material, the moisture content or wet pickup of the textile material following application of the liquid treatment composition, or the temperature at which the textile material is dried. Generally, the textile material or garment is dried for an amount of time sufficient to reduce its moisture content to about 10% or less or about 4% or less.

The following examples further illustrate the subject matter described above but, of course, should not be construed as in any way limiting the scope thereof.

### Example 1

This example demonstrates the production of treated textile materials according to the invention. 3×1 left-hand twill weave fabrics were provided for processing as described in the instant specification. The fabrics' warp yarns were spun yarns comprising a blend of 50% by weight cotton fibers and 50% by weight nylon 6,6 fibers. The fabrics' filling yarns were spun yarns comprising a blend of meta-aramid fibers and para-aramid fibers sold by DuPont under the name NOMEX® IIIA. Due to the twill construction of the fabrics, the faces of the fabrics, which will face away from the user when the fabrics are sewn into garments and worn, contain a higher proportion of warp yarns than filling yarns.

The fabrics were treated with a tetrakis(hydroxymethyl)phosphonium chloride-urea pre-condensate and cured in the presence of gaseous ammonia to produce a flame retardant finish on the fabrics according to procedures described in the instant specification. Following the application of the flame retardant finish, the fabrics were sewn into garments.

The garments were sprayed with an aqueous emulsion containing approximately 1.2% by weight of PERMANONE® 40 concentrate, which contained approximately 40% by weight permethrin in naphtha, and approximately 4% by weight of an acrylic latex, which contained approximately 45% by weight solids. The garments were sprayed with the aqueous emulsion until the wet pickup was approximately 80%. The garments were then dried in a tumble dryer for approximately 45 minutes.

Four samples were then drawn from the garments. The first two samples, Samples 1A and 1B, were tested to determine the initial concentration of the insect repellent compound (i.e., permethrin) on each fabric sample's face and back. The second two samples, Samples 1C and 1D, were tested to determine the concentration of insect repellent compound (i.e., permethrin) on each fabric sample's face and back after the fabrics had been washed ten times. The amount of insect repellent on the fabric face and fabric back was determined by first separating the warp yarns and filling yarns from the fabric sample. Each set of yarns was then immersed in chloroform to extract the insect repellent compound, and the chloroform was analyzed using gas chromatography mass spectrometry to determine the amount of insect repellent compound in the chloroform. These results were then used to express the amount of insect repellent compound on the fabric in milligrams per square centimeter of fabric (mg/cm²). Due to the fact that the warp yarns account for the majority of the surface area of the fabric's face, the result obtained for the warp yarns is reported as the amount on the face of the fabric (i.e., the side of the fabric facing away from the wearer). Conversely, the result obtained for the filling yarns is reported as the amount on the back of the fabric. The results obtained are reported in Table 1 below.

TABLE 1
Insect repellent concentration on the fabric
face and fabric back of Samples 1A-1D.

Insect Repellent Concentration (mg/cm²)

| Sample | Fabric Face | Fabric Back |
|---|---|---|
| 1A | 0.85 | 0.49 |
| 1C | 0.54 | 0.29 |
| 1B | 0.86 | 0.51 |
| 1D | 0.53 | 0.3 |

As can be seen from the results set forth in Table 1, the fabric face, which has a surface in which the warp yarns predominate, exhibited a higher concentration of insect repellent compound than the fabric back. Furthermore, the relative amount of insect repellent compound on the fabric face and fabric back remained substantially unchanged after the fabrics had been washed ten times. Applicants believe that the higher concentration of the insect repellent compound on the fabric's face is advantageous because it puts a greater amount of the insect repellent in the place where it is most likely to be effective, the outside of the garment. Also, applicants believe that the lower amount of insect repellent on the fabric back may be advantageous because the fabric surface in contact with the wearer's skin will have less insect repellent compound. This may, in turn, lower the wearer's exposure to the insect repellent compound and reduce the likelihood of irritation or other harm resulting from exposure to the insect repellent compound.

### Example 2

This example demonstrates the production of treated textile materials according to the invention. Four flame resistant garments (two trousers and two coats) were made from 3×1 left-hand twill weave fabrics similar to that described in Example 1. The fabrics were treated with a tetrakis(hydroxymethyl)phosphonium chloride-urea precondensate flame retardant as described in Example 1.

The garments were then sprayed with an aqueous emulsion containing approximately 1.2% by weight of PERMANONE® 40 concentrate, which contained approximately 40% by weight permethrin in naphtha, and approximately 4% by weight of an acrylic latex, which contained approximately 45% by weight solids. The garments were sprayed with the aqueous emulsion until the wet pickup was approximately 57%. The garments were then dried in a tumble dryer.

A sample was then drawn from each trouser (Sample 2A and Sample 2B) and each coat (Sample 2C and 2D). These samples were used to determine the initial concentration of insect repellent on the fabric, as described below. The garments were then washed twenty times under typical home laundry conditions, and a sample was then drawn from each trouser (Sample 2E and Sample 2F) and each coat (Sample 2G and 2H). Sample 2E was drawn from the same trouser as Sample 2A, Sample 2F was drawn from the same trouser as Sample 2B, Sample 2G was drawn from the same coat as Sample 2C, and Sample 2H was drawn from the same coat as Sample 2D.

The amount of insect repellent on the samples was determined by immersing the sample in chloroform to extract the insect repellent compound and then analyzing the chloroform using gas chromatography mass spectrometry to determine the amount of insect repellent compound in the chloroform. These results were then used to express the amount of insect repellent compound on the fabric in milligrams per square centimeter of fabric (mg/cm²). The result for each sample is set forth in Table 2 below.

TABLE 2
Insect repellent concentration on each of Samples 2A-2H.

| Sample | Insect Repellent Concentration (mg/cm²) |
|---|---|
| 2A | 0.112 |
| 2E | 0.076 |
| 2B | 0.114 |
| 2F | 0.061 |
| 2C | 0.114 |
| 2G | 0.068 |
| 2D | 0.118 |
| 2H | 0.054 |

As can be seem from the data set forth in Table 2, the garments treated in accordance with the invention initially have an appreciable amount of insect repellent compound deposited on them. Furthermore, while the concentration of insect repellent compound is reduced by laundering the garments, there is still an appreciable amount of the insect repellent on the garments after twenty washes and such amount may be sufficient to provide some protection from insects.

### Example 3

This example demonstrates the production of treated textile materials according to the invention. Four flame resistant garments (two trousers and two coats) were made from 3×1 left-hand twill weave fabrics similar to that described in Example 1 and were treated with a flame retardant and insect repellent compound using processes similar to those described in Example 2.

Three samples were drawn from each trouser and each coat and were tested to determine their efficacy for repelling certain insects. More specifically, the samples were tested in accordance with the procedure described in Purchase Description MIL-PRF-MCCUU C dated Aug. 12, 2004 and Attachment 2 dated Apr. 18, 2006. In general, the test described in the Purchase Description measures a treated textile material's effectiveness at repelling certain mosquitoes (i.e., Aedes (Stegomyia) aegypti (“Ae. aeg.”) and Anopheles albimanus (“An. alb.”)) by comparing the number of bites a human subject receives within a test area on an arm that is covered by the treated textile material to the number of bites the human subject receives within a test area on the opposite arm that is covered by an untreated control textile material. To permit a fair comparison, the human subject's arms are inserted into a cage having a specified volume and containing a known number of mosquitoes. The result is expressed as a Percent Bite Protection, in which 100% is the maximum value and indicates that the human subject wearing the treated textile material received no bites in the test area. The test described in the Purchase Description also measures the effectiveness of treated textile materials that have been washed twenty times and fifty times under certain specified conditions. The results obtained for the tests on the garment samples described above are set forth in Table 3 below.

TABLE 3
Bite protection data for samples from Example 3.

| | Spec- | Initial Bite | | 20 Wash Bite | | 50 Wash Bite | |
|---|---|---|---|---|---|---|---|
| Sam- | imen | Protection | | Protection | | Protection | |
| ple | Number | Ae. aeg. | An. alb. | Ae. aeg. | An. alb. | Ae. aeg. | An. alb. |
| Coat | 1 | 95.2% | 100.0% | 98.4% | 100.0% | 97.4% | 100.0% |
| 1 | 2 | 100.0% | 98.9% | 93.7% | 97.6% | 94.3% | 98.7% |
| | 3 | 94.4% | 97.4% | 94.6% | 99.1% | 94.7% | 99.0% |
| | Average | 96.5% | 98.8% | 95.6% | 98.9% | 95.5% | 99.2% |
| Coat | 1 | 98.4% | 100.0% | 97.5% | 99.1% | 90.0% | 100.0% |
| 2 | 2 | 95.5% | 93.1% | 97.0% | 98.9% | 96.9% | 100.0% |
| | 3 | 94.4% | 94.5% | 97.9% | 95.9% | 96.2% | 96.4% |
| | Average | 96.1% | 95.9% | 97.5% | 98.0% | 94.4% | 98.8% |
| Trou- | 1 | 97.3% | 98.0% | 98.3% | 99.0% | 97.4% | 100.0% |
| ser 1 | 2 | 97.5% | 93.8% | 97.5% | 92.4% | 96.2% | 98.8% |
| | 3 | 95.3% | 96.2% | 97.4% | 98.5% | 93.8% | 97.9% |
| | Average | 96.7% | 96.0% | 97.7% | 96.6% | 95.8% | 98.9% |
| Trou- | 1 | 99.2% | 100.0% | 98.3% | 100.0% | 99.3% | 100.0% |
| ser 2 | 2 | 98.0% | 96.7% | 97.3% | 97.4% | 98.1% | 95.3% |
| | 3 | 98.7% | 96.7% | 95.0% | 96.3% | 95.9% | 100.0% |
| | Average | 98.6% | 97.8% | 96.9% | 97.9% | 97.8% | 98.4% |
| | Overall | 98.4% | 97.1% | 96.4% | 97.2% | 97.3% | 97.9% |
| | Average | | | | | | |

As can be seen from the data set forth in Table 3, the textile materials according to the invention can afford significant protection from mosquito bites and can continue to provide such protection even after the garments have been repeatedly washed. Accordingly, Applicants believe that the textile materials according to the invention may be particularly useful in protecting users from insect bites (e.g., mosquito bites) in those situations in which frequent reapplication of an insect repellent treatment is impractical.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A treated textile material comprising:
(a) a textile substrate comprising a plurality of first yarns and a plurality of second yarns, the first yarns comprising cellulosic fibers, the cellulosic fibers comprising about 35% or more, by weight, of the fibers present in the first yarns, the second yarns comprising synthetic fibers, the synthetic fibers comprising about 70% or more, by weight, of the fibers present in the second yarns, the first yarns being disposed in a first direction in the textile substrate and the second yarns being disposed in a second direction perpendicular to the first direction, the first yarns and second yarns being further disposed within the textile substrate in a patternwise arrangement in which the first yarns are predominantly disposed on a first surface of the textile substrate and the second yarns are predominantly disposed on a second surface of the textile substrate opposite the first surface; and
(b) an insect repellent compound selected from the group consisting of pyrethrins, pyrethroids, icaridin, and mixtures thereof, the insect repellent compound being predominantly disposed on the first surface of the textile substrate.

2. The treated textile material of claim 1, wherein the cellulosic fibers are cotton fibers.

3. The treated textile material of claim 1, wherein the cellulosic fibers comprise about 40% or more, by weight, of the fibers present in the first yarns.

4. The treated textile material of claim 3, wherein the cellulosic fibers comprise about 45% or more, by weight, of the fibers present in the first yarns.

5. The treated textile material of claim 1, wherein the first yarns comprise a blend of cellulosic fibers and thermoplastic synthetic fibers.

6. The treated textile material of claim 5, wherein the thermoplastic synthetic fibers are selected from the group consisting of polyester fibers, polyamide fibers, polyvinyl alcohol fibers, and mixtures thereof.

7. The treated textile material of claim 6, wherein the thermoplastic synthetic fibers are polyamide fibers.

8. The treated textile material of claim 5, wherein the thermoplastic synthetic fibers comprise about 40% or more, by weight, of the fibers present in the first yarns.

9. The treated textile material of claim 8, wherein the thermoplastic synthetic fibers comprise about 50% or more, by weight, of the fibers present in the first yarns.

10. The treated textile material of claim 1, wherein the synthetic fibers in the second yarns are aramid fibers.

11. The treated textile material of claim 10, wherein the second yarns comprise meta-aramid fibers.

12. The treated textile material of claim 1, wherein the synthetic fibers comprise about 80% or more, by weight, of the fibers present in the second yarns.

13. The treated textile material of claim 10, wherein the second yarns comprise a blend of meta-aramid fibers and para-aramid fibers.

14. The treated textile material of claim 13, wherein the second yarns comprise about 90% to about 95%, by weight, meta-aramid fibers and about 1% to about 10%, by weight, para-aramid fibers.

15. The treated textile material of claim 1, wherein the treated textile material further comprises a flame retardant finish applied to at least the first surface of the textile substrate.

16. The treated textile material of claim 15, wherein the flame retardant finish comprises a phosphorous-containing compound polymerized within at least a portion of the cellulosic fibers, the phosphorous-containing compound being a product produced by heat-curing and oxidizing a reaction mixture comprising:
(i) a first chemical selected from the group consisting of tetrahydroxymethyl phosphonium salts, condensates of tetrahydroxymethyl phosphonium salts, and mixtures thereof; and
(ii) a cross-linking agent selected from the group consisting of urea, guanidines, guanyl urea, glycoluril, ammonia, ammonia-formaldehyde adducts, ammonia-acetaldehyde adducts, ammonia-butyraldehyde adducts, ammonia-chloral adducts, glucosamine, polyamines, glycidyl ethers, isocyanates, blocked isocyanates, and mixtures thereof.

17. The treated textile material of claim 16, wherein the cross-linking agent is urea.

18. The treated textile material of claim 1, wherein the first and second yarns are disposed in a woven pattern selected from the group consisting of satin weaves, sateen weaves, and twill weaves.

19. The treated textile material of claim 1, wherein the treated textile material further comprises a binder, at least a portion of the binder being disposed on the first surface of the textile substrate.

20. The treated textile material of claim 19, wherein the binder is selected from the group consisting of acrylic copolymers, vinyl chloride copolymers, ethylene-vinyl acetate copolymers, styrene-butadiene copolymers, polyurethanes, polyolefins, and mixtures thereof.

21. A garment comprising the treated textile material of claim 1.

22. A process for treating a garment, the process comprising the steps of:
(a) providing a garment, the garment comprising a textile substrate, the textile substrate comprising a plurality of first yarns and a plurality of second yarns, the first yarns comprising cellulosic fibers, the cellulosic fibers comprising about 35% or more, by weight, of the fibers present in the first yarns, the second yarns comprising synthetic fibers, the synthetic fibers comprising about 70% or more, by weight, of the fibers present in the second yarns, the first yarns being disposed in a first direction in the textile substrate and the second yarns being disposed in a second direction perpendicular to the first direction, the first yarns and second yarns being further disposed within the textile substrate in a patternwise arrangement in which the first yarns are predominantly disposed on a first surface of the textile substrate and the second yarns are predominantly disposed on a second surface of the textile substrate opposite the first surface;
(b) providing a liquid treatment composition, the treatment composition comprising an insect repellent compound selected from the group consisting of pyrethrins, pyrethroids, icaridin, and mixtures thereof;
(c) applying the liquid treatment composition to the garment; and
(d) drying the garment.

23. The process of claim 22, wherein the liquid treatment composition further comprises a binder.

24. The process of claim 23, wherein the binder is selected from the group consisting of acrylic copolymers, vinyl chloride copolymers, ethylene-vinyl acetate copolymers, styrene-butadiene copolymers, polyurethanes, polyolefins, and mixtures thereof.

25. The process of claim 22, wherein the liquid treatment composition further comprises an emulsifying agent.

26. The process of claim 22, wherein the garment is dried at a temperature of about 35° C. to about 85° C.
